(19) United States
(12) Patent Application Publication
(10) Pub. No.: US 2015/0037028 A1
(43) Pub. Date: Feb. 5, 2015

(54) ADAPTIVE DISTRIBUTED ANTENNA SYSTEM CAPABLE OF LOAD BALANCING

(71) Applicant: AMOESOLU CORPORATION, Taipei City (TW)

(72) Inventors: Terng-Yin HSU, Taipei City (TW); Cheng-Yen CHEN, Taipei City (TW); Wen-Jye HUANG, Taipei City (TW); Ray-Shiang JEAN, Taipei City (TW); Shao-Ying YEH, Taipei City (TW); You-Hsien LIN, Taipei City (TW)

(73) Assignee: AMOESOLU CORPORATION, Taipei City (TW)

(21) Appl. No.: 14/222,583

(22) Filed: Mar. 21, 2014

(30) Foreign Application Priority Data
Aug. 2, 2013 (TW) 102127823

(51) Int. Cl. H04B 10/2575; H04J 14/02

(52) U.S. Cl. CPC H04B 10/25753; H04J 14/0278
USPC 398/46; 398/115; 398/49

(57) ABSTRACT

An adaptive distributed antenna system comprises a control module coupled between multiple base stations, and multiple antenna groups, each of which includes multiple antenna devices each coupled to the control module via a transmission line, and operable to convert an external wireless signal and a transmitting signal from the transmission line respectively into a receiving signal and a signal to be radiated. The control module converts a downlink signal from any base station and the receiving signal from any transmission line respectively into the transmitting signal and an uplink signal. The control module is configured to establish a transmission link between one base station and one antenna device of the antenna groups.

### CROSS-REFERENCE TO RELATED APPLICATION

This application claims priority to Taiwanese Application No. 102127823, filed on Aug. 2, 2013, the contents of which are hereby incorporated by reference.

### BACKGROUND OF THE INVENTION

1. Field of the Invention

The invention relates to a distributed antenna system, and more particularly to an adaptive distributed antenna system.

2. Description of the Related Art

Referring to FIG. 1, a conventional distributed antenna system 900 is shown to include a base station 91, a head-end unit (HEU) 92 (or a master controller) coupled to the base station 91, and a plurality of antenna devices 93 coupled to the HEU 92 through a transmission line 94, such as a fiber optic cable. The HEU 92 serves to convert a radio frequency (RF) signal from the base station 91 into a first converted signal, such as an optical signal, which is to be fed into the transmission line 94. Each antenna device 93 includes a remote antenna unit (RAU) 931 coupled to the transmission line 94, and an antenna 932 coupled to the RAU 931. For each antenna device 93, the RAU 931 serves to convert the first converted signal from the transmission line 94 into a RF signal, which is radiated by the antenna 932. Similarly, the RAU 931 also serves to convert an RF signal received by the antenna 932 into a second converted signal, such as an optical signal, which is fed into the transmission line 94. The HEU 92 also serves to convert the second converted signal from the transmission line 94 into an RF signal, which is outputted to the base station 91.

In such a configuration, the antenna devices 93, which are coupled to the base station 91 through the transmission line 94, are distributed to thereby provide an extended service coverage area of the system 900 at a relatively low installation cost for the base station 91.

However, it is therefore desirable to develop a distributed antenna system capable of providing specific or adaptive transmission configuration so as to effectively and variously utilize operation of system resources.

### SUMMARY OF THE INVENTION

Therefore, an object of the present invention is to provide an adaptive distributed antenna system that can achieve specific or adaptive signal transmission.

According to the present invention, an adaptive distributed antenna system comprises a plurality of base stations, a plurality of antenna groups, and a control module.

Each of the antenna groups includes a transmission line, and a plurality of antenna devices, each of which is coupled to the transmission line and is operable to convert any wireless signal received thereby into a signal serving as a receiving signal to be fed into the transmission line, and to convert any transmitting signal transmitted from the transmission line into a signal to be radiated.

The control module is coupled between the base stations and the transmission lines of the antenna groups. The control module is operable to convert a downlink signal from any one of the base stations into a signal serving as the transmitting signal to be fed into the transmission line of one of the antenna groups, and to convert the receiving signal transmitted from the transmission line of any one of the antenna groups into a signal serving as an uplink signal to be transmitted to one of the base stations for further processing of the uplink signal. The control module is configured to establish a transmission link between at least one of the base stations and at least one of the antenna devices of the antenna groups.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a conventional distributed antenna system; and

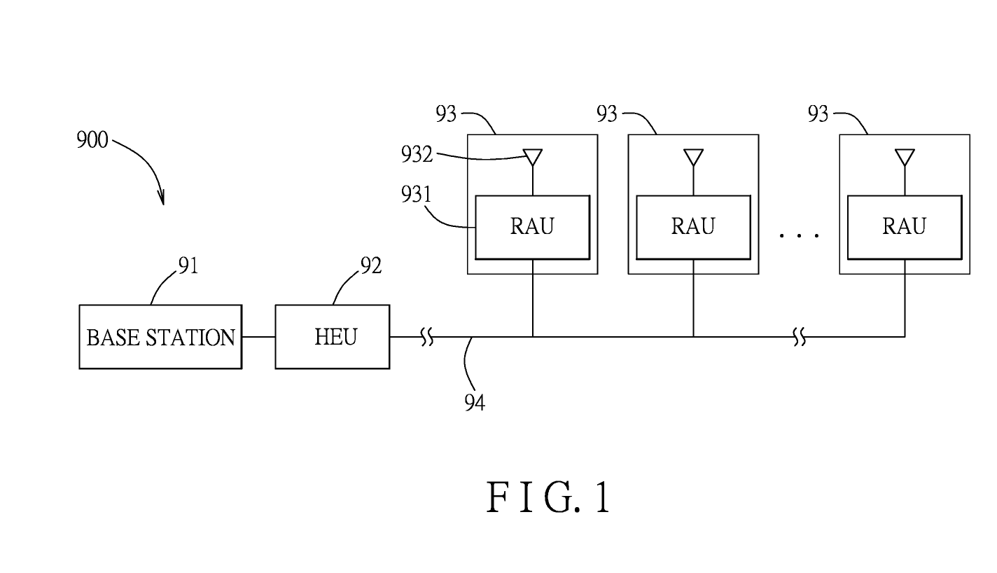

FIG. 2 is a schematic block diagram illustrating the preferred embodiment of an adaptive distributed antenna system according to the present invention.

### DETAILED DESCRIPTION OF THE PREFERRED EMBODIMENT

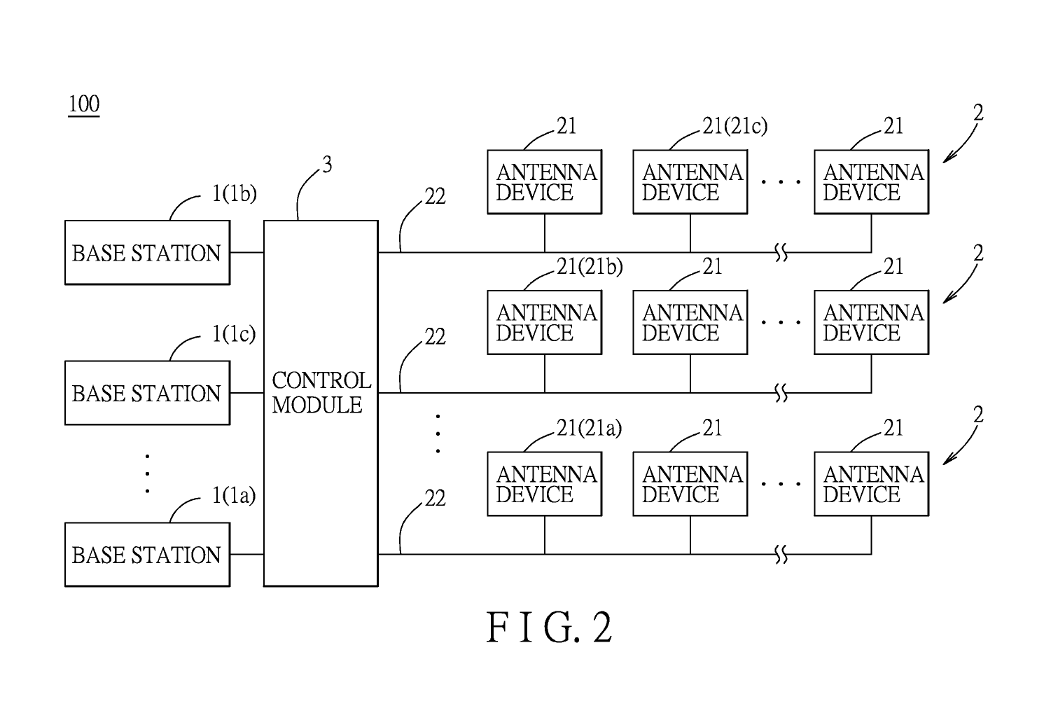

Referring to FIG. 2, the preferred embodiment of an adaptive distributed antenna system 100 according to the present invention is shown to include a plurality of base stations 1, a plurality of antenna groups 2, and a control module 3.

Each base station 1 is configured to process radio frequency signals in a known manner. Since the feature of this invention does not reside in the configuration of the base stations 1, which is known to those skilled in the art, details of the same are omitted herein for the sake of brevity.

Each antenna group 2 includes a plurality of antenna devices 21, and a transmission line 22 coupled to the antenna devices 21. For each antenna group 2, each antenna device 21 is located in a corresponding service area, and is operable to convert any wireless signal, such as a radio frequency (RF) signal, received thereby into a signal serving as a receiving signal to be fed into the transmission line 22, and to convert any transmitting signal transmitted from the transmission line 22 into a signal to be radiated. In this embodiment, the transmission line 22 is a fiber optic cable, and each antenna device 21 of each antenna group 2 has optic-electro and electro-optic conversion functionalities. More specifically, for each antenna group 2, each antenna device 21 is capable of converting the transmitting signal, which is an optical signal, from the transmission line 22 into an electrical signal that serves as the signal to be radiated, and converting the wireless signal, which is an electrical signal, into an optical signal that serves as the receiving signal. In other embodiments, the transmission line 22 can be a coaxial cable.

The control module 3 is coupled between the base stations 1 and the transmission lines 22 of the antenna groups 2. The control module 3 is operable to convert a downlink signal from any one of the base stations 1 into a signal serving as the transmitting signal to be fed into the transmission line 22 of one antenna group 2, and to convert the receiving signal transmitted from the transmission line 22 of any one of the antenna groups 2 into a signal serving as an uplink signal to be transmitted to one base station 1 for further processing of the uplink signal. In this embodiment, since each transmission line 22 is a fiber optic cable, the control module 3 also has optic-electro and electro-optic conversion functionalities. Therefore, the control module 3 is capable of converting the downlink signal, which is an electrical signal, into an optical signal that serves as the transmitting signal, and converting the receiving signal, which is an optical signal, into an electrical signal that serves as the uplink signal. It is noted that the control module 3 is configured to establish a transmission link between at least one of the base stations 1 and at least one of the antenna devices of the antenna groups 2, thereby satisfying communication requirements in certain one(s) of the service areas. For example, the control module 3 establishes a first transmission link between the base station (1c) and the antenna devices (21a, 21b) or a second transmission link between the base stations (1b, 1c) and the antenna device (21c).

In this embodiment, the control module 3 establishes the transmission link between the at least one of the base stations 1 and the at least one of the antenna devices 21 of the antenna groups 2 using wavelength division multiplexing (WDM). In the other embodiments, when each transmission line 3 is a coaxial cable, the control module 3 establishes the transmission link between the at least one of the base stations 1 and the at least one of the antenna devices 21 of the antenna groups 2 using frequency division multiplexing (FDM) or orthogonal frequency division multiplexing (OFDM). As a result, the control module 3 is capable of carrying out multi-carrier communication with each of the antenna devices 21 of the antenna groups 2.

On the other hand, the transmission link between the least one of the base stations 1 and the at least one of the antenna devices 21 of the antenna groups 2 is determined based on an amount of data being transmitted through each of the antenna devices 21 of the antenna groups 2. For example, in a case where the control module 3 originally establishes a transmission link between the base station (1b) and the antenna devices (21c), when the amount of data currently being transmitted through the antenna device (21c) increases and becomes greater than a predetermined transmission threshold, the control module 3 re-establishes an adaptive transmission link between the base stations (1b, 1c) and the antenna device (21c), thereby satisfying communication requirements for the antenna device (21c).

Further, the transmission link between the at least one of the base stations 1 and the at least one of the antenna devices 21 of the antenna groups 2 is determined based on a user density of each of the antenna devices 21 of the antenna groups 2. The user density of each antenna device 21 represents the number of user terminals, such as mobile communication devices, currently communicating with the antenna device 21. For example, in the above case, when the user density of the antenna device (21c) increases and becomes greater than a predetermined user density threshold, the control module 3 re-establishes an adaptive transmission link between the base stations (1b, 1c) and the antenna device (21c), thereby satisfying communication requirements for the antenna device (21c).

Additionally, the transmission link between the at least one of the base stations 1 and the at least one of the antenna devices 21 of the antenna groups 2 is determined based on a signal transmission quality of each of the antenna devices 21 of the antenna groups 2. For example, in another case where the control module 3 originally establishes a transmission link between the base station (1b) and the antenna device (21c) and where the base station (1b) has a larger load capacity compared to the base station (1c), when the signal transmission quality of the antenna device (21c) degrades due to increased noise and becomes lower than a predetermined transmission quality threshold, the control module 3 re-establishes an adaptive transmission link between the base station (1c) and the antenna device (21c), thereby avoiding the waste of transmission resources of the base station (1b).

To sum up, the control module 3 is able to adaptively adjust a coverage area of each base station 1 by establishing a transmission link between a corresponding base station 1 and adequate one(s) of the antenna devices 21 of the antenna groups 2 to cause communications loading to be rebalanced to thereby enable efficient use of transmission resources and optimize the overall performance of the adaptive distributed antenna system 100 of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An adaptive distributed antenna system comprising:
a plurality of base stations;
a plurality of antenna groups each including a transmission line, and a plurality of antenna devices, each of which is coupled to said transmission line and is operable to convert any wireless signal received thereby into a signal serving as a receiving signal to be fed into said transmission line, and to convert any transmitting signal transmitted from said transmission line into a signal to be radiated; and
a control module coupled between said base stations and said transmission lines of said antenna groups, said control module being operable to convert a downlink signal from any one of said base stations into a signal serving as the transmitting signal to be fed into said transmission line of one of said antenna groups, and to convert the receiving signal transmitted from said transmission line of anyone of said antenna groups into a signal serving as an uplink signal to be transmitted to one of said base stations for further processing of the uplink signal;
wherein said control module is configured to establish a transmission link between at least one of said base stations and at least one of said antenna devices of said antenna groups.

2. The adaptive distributed antenna system as claimed in claim 1, wherein the transmission link between the at least one of said base stations and the at least one of said antenna devices of said antenna groups is determined based on an amount of data being transmitted through each of said antenna devices of said antenna groups.

3. The adaptive distributed antenna system as claimed in claim 1, wherein the transmission link between the at least one of said base stations and the at least one of said antenna devices of said antenna groups is determined based on a user density of each of said antenna devices of said antenna groups.

4. The adaptive distributed antenna system as claimed in claim 1, wherein the transmission link between the at least one of said base stations and the at least one of said antenna devices of said antenna groups is determined based on a signal transmission quality of each of said antenna devices of said antenna groups.

5. The adaptive distributed antenna system as claimed in claim 1, wherein said transmission line of each of said antenna groups is a fiber optic cable.

6. The adaptive distributed antenna system as claimed in claim 5, wherein:
for each of said antenna groups, each of said antenna devices is capable of converting the transmitting signal, which is an optical signal, from said transmission line into an electrical signal that serves as the signal to be radiated, and converting the wireless signal, which is an electrical signal, into an optical signal that serves as the receiving signal; and
said control module is capable of converting the downlink signal, which is an electrical signal, into an optical signal that serves as the transmitting signal, and converting the receiving signal, which is an optical signal, into the an electrical signal that serves as the uplink signal.

7. The adaptive distributed antenna system as claimed in claim 5, wherein the transmission link between the at least one of said base stations and the at least one of said antenna devices of said antenna groups is established by said control module using wavelength division multiplexing (WDM).

8. The adaptive distributed antenna system as claimed in claim 1, wherein said transmission line of each of said antenna groups is a coaxial cable.

9. The adaptive distributed antenna system as claimed in claim 8, wherein the transmission link between the at least one of said base stations and the at least one of said antenna devices of said antenna groups is established by said control module using frequency division multiplexing (FDM) or orthogonal frequency division multiplexing (OFDM).

10. The adaptive distributed antenna system as claimed in claim 1, wherein said control module is capable of carrying out multi-carrier communication with each of said antenna devices of said antenna groups.
